(19) United States
(12) Patent Application Publication
(10) Pub. No.: US 2005/0013023 A1
(43) Pub. Date: Jan. 20, 2005

(54) Remote controlled crossview mirror

(76) Inventor: William Paul Schmidt, Newport, MI (US)

Correspondence Address: Steven W. Hays, Suite 250, 28333 Telegraph Road, Southfield, MI, 48034, US

(21) Appl. No.: 10/621,131

(22) Filed: Jul. 16, 2003

(51) Int. Cl. G02B 5/08; G02B 7/182

(52) U.S. Cl. 359/873

(57) ABSTRACT

A remote controlled crossview mirror assembly for use on a vehicle that allows a vehicle operator to adjust an arcuate mirror leftward and rightward to improve the field of vision directly in front of and to the side of the vehicle. To operate the assembly, the operator first activates an electronic controller contained within the cab region. The electronic controller sends an electrical signal to an electronic actuator. The electronic actuator interprets the electronic signal and rotates about a fixed center point in a clockwise or counterclockwise direction along a horizontal plane, thereby adjusting a coupled arcuate mirror to improve the operator's field of vision directly in front of and to the side of the vehicle.

### TECHNICAL FIELD AND INDUSTRIAL APPLICABILITY OF THE INVENTION

The present invention relates generally to a mirror assembly and more particularly to a remote controlled crossview mirror.

### BACKGROUND OF THE INVENTION

Mirrors have been known to man for many centuries. The mirrors made by the ancient Greeks and Romans were mostly made from polished bronze, but glass mirrors were also known. During the middle ages, a process for backing glass with a thin layer of silver and steel was developed. This enabled the rising middle class people to acquire mirrors.

Today, mirrors are used in a variety of wide ranging applications such as astronomy, space ships, solar devices, vehicles, microscopes, satellite communication devices and medicine. Perhaps the best-known application for mirrors, are mirrors for motor vehicles.

Motor vehicles require mirrors in order to provide the driver or operator of the vehicle, the widest possible field of view around his vehicle. This is done for safety purposes since most vehicles, due to structural obstructions, have “blind spots” which prevent the driver from seeing any object that may come near the front, rear or sides of the vehicle. For years, the automobile designers have attempted to eliminate these blind spots when designing vehicles. Unfortunately, this objective can never be achieved because of the design of the motor vehicle. Thus, it has been found necessary to mount mirrors in and around the vehicle to enhance the field of view of the driver.

One early attempt to enhance the operator's rear field of view is disclosed in U.S. Pat. No. 2,969,715 to Moseby. Moseby increases the driver's field of view by mounting a very large rear-view mirror to one side of the vehicle. While this increased the field of view, it presented other undesirable structural and safety problems.

Another attempt to overcome this problem is disclosed by Fellmeth, U.S. Pat. No. 2,778,273, issued Jan. 22, 1957. Fellmeth uses a mirror with a flat intermediate portion and a convex edge portion. He mounts the mirror adjacent to the left-hand front door or operator's door so that objects proximate to the side, bottom and rear of the vehicle are reflected in the curved and convex peripheral portion of the mirror. Objects, in the far distance rearward, however, are reflected in the medial flat portion. This mirror construction also presents other structural and safety problems.

West in U.S. Pat. No. 2,911,177, issued Nov. 3, 1959, discloses a generally spherical segment-shaped reflecting panel with a flat part insert therein.

King in U.S. Pat. No. 3,104,274; Kalutich in U.S. Pat. No. 3,170,985 and Tobin in U.S. Pat. No. 3,389,952 are further examples of convex rear-view mirrors that are used in combination with larger flat mirrors to enhance the rearward view of the operator of the vehicle. However, all these aforementioned designs have inherent safety and structural problems in that the mirrors generally project a substantial distance outwardly from the vehicle.

Jenkins in U.S. Pat. No. 3,003,396, issued Nov. 10, 1961, discloses a convex rear-view mirror that is mounted inside the vehicle. Jenkins modifies a convex rear-view mirror by gradually increasing the curvature at the ends. This curvature substantially minimizes the distortion of objects. Unfortunately, Jenkins still does not provide a wide enough field of view to eliminate many or most of the blind spots in front of, on the sides and to the rear of the vehicle.

None of the aforementioned prior art mirrors have been successfully employed in school buses to reduce “blind spots” in front of the vehicle. Thus, the National Safety Council has reported 58,000 annual school bus accidents occurring nationally in 1977 and 1978 and approximately 165 fatalities per year. A Kansas Department of Transportation study of these national school bus fatalities pinpoints the contributing factors. From 1975 through 1978, 73 percent of the fatalities were among homeward bound pupils; 60 percent of the pupils were killed by the bus itself; and 47 percent were 5 and 6 years old. These statistics indicate that enhancing the driver's view in front of and around the vehicle could reduce these fatalities.

One mirror that has been designed to reduce blind spots in front of a vehicle such as a bus is a crossover mirror. Crossover mirrors have been designed and mounted to the front corner of the bus to provide the driver with visual access to the area in front of the bus that is hidden from direct view as well as to the sides of the bus. Currently available crossover mirrors are required to see a particular forward, rightward and leftward visual orientation in front of school buses as mandated by FMVSS (Federal Motor Vehicle Safety Standard) 111. Under FMVSS 111, the school bus builder certifies mirror compliance using the eye ellipses of a 25^{th} percentile women driver when the school bus is sold. However, when the school bus enters service, the mirror must be manually adjusted rightward or leftward depending upon the individual bus operator.

Manual adjustment, unfortunately, is a time consuming process that typically requires two people—one inside the bus and one adjusting the mirror—to ensure proper adjustment. Further, if the process is not performed properly, blind spots may occur in front of or along the side of the vehicle.

### SUMMARY OF THE INVENTION

It is therefore an object of the present invention to provide an easier method for adjusting a crossover mirror for use on a vehicle such as a school bus.

The present invention addresses this object by providing an electronically controlled crossover mirror controllable by the operator from the cab of the vehicle. An electronic controller preferably mounted to the dashboard of the cab region of the vehicle coupled to an actuator within the mirror allows the mirror to swivel clockwise or counterclockwise about a vertical mounting reference. This allows the mirror to be adjusted rightward or leftward as seen by the operator of the vehicle to ensure the minimization of blind spots in front of and along the side of the vehicle. Properly adjusted mirrors will add greater safety to the children who ride the bus every day.

Other objects and advantages of the present invention will become apparent upon considering the following detailed description and appended claims, and upon reference to the accompanying drawings.

### BRIEF DESCRIPTION OF THE DRAWINGS

FIG. 1 is a perspective view of a school bus having a mirror assembly according to one embodiment of the present invention;

FIG. 2 is a perspective view of a mirror assembly according to one embodiment of the present invention;

FIG. 3 is a section view of the mirror assembly of FIG. 2 in the direction of the arrows 3-3;

FIG. 4 is a sectional view from the front of a mirror assembly according to one embodiment of the present invention;

FIG. 5 is a cross-sectional view of the mirror assembly of FIG. 4 in the direction of the arrows 5-5; and

FIG. 6 is a perspective view of an electronic controller according to another embodiment of the present invention.

### DETAILED DESCRIPTION AND PREFERRED EMBODIMENTS OF THE INVENTION

Referring to FIG. 1, a motor vehicle 10, preferably a school bus, has a hood 12 and front fenders 14 and 16. Alternatively, the motor vehicle is a truck, recreational vehicle, van, station wagon, car, or any other similar vehicle. The hood 12 often causes a large area in front of the school bus to be hidden from direct view of the driver sitting in the cab area 17, particularly in view of its height from the ground. Heretofore, children have been injured or killed when standing in this area as the bus moves forwardly.

To address these problems, mirror mounting supports 18 and 20 are mounted on the fenders 14 and 16. The mounting supports 18 are preferably hollow. Thereafter, elongated, arcuate mirror assemblies 22 and 24 are mounted on the supports 18 and 20 and with the mirror assemblies positioned so that the driver can see the hidden area in front of the school bus 10 and the areas alongside the school bus 10 clearly and with minimum distortion from the cab 17 during bus operation. Preferably, the mirror assemblies 22, 24 are mounted such that the “blind spot” behind each mirror 26 is fully disclosed in the other mirror.

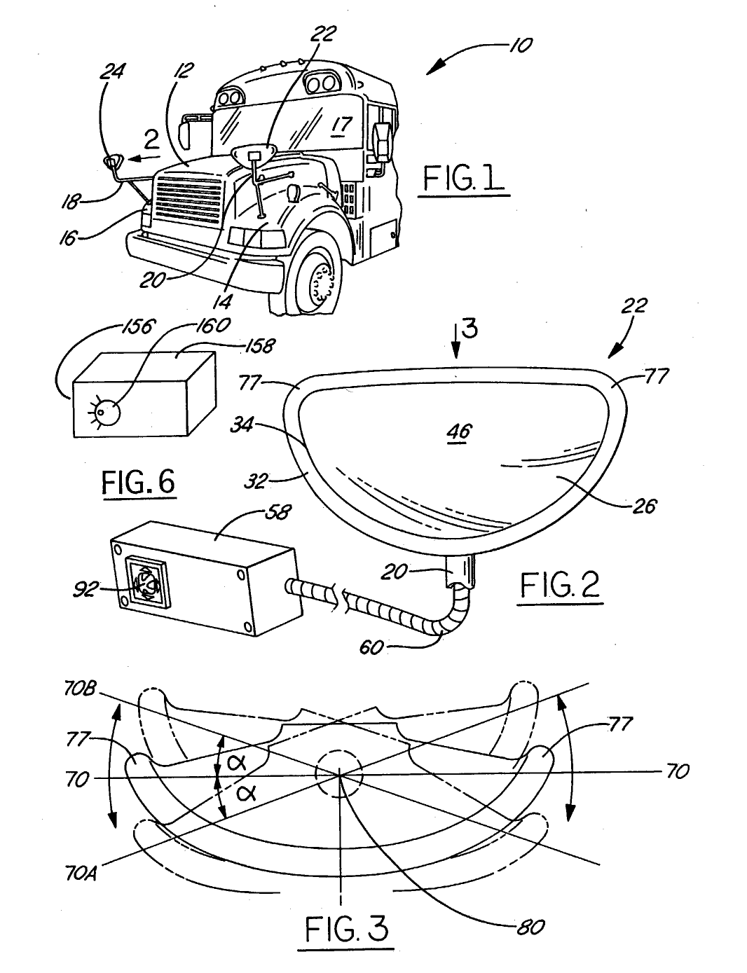

Each of the mirror assemblies 22 and 24 are preferably similar to one another. However, they may take on a variety of different configurations. The mirror assembly 22 is shown more particularly in FIGS. 2-5 and in one embodiment includes an elongate, arcuate mirror 26 having a reflective surface 46 with a generally convex shape throughout. The mirror 26 is mounted in a frame 28 having a curved back plate 30 and turned in edges 32. The edges 32 are turned over the edges of the mirror 26 with a suitable vinyl or rubber layer 34 there between.

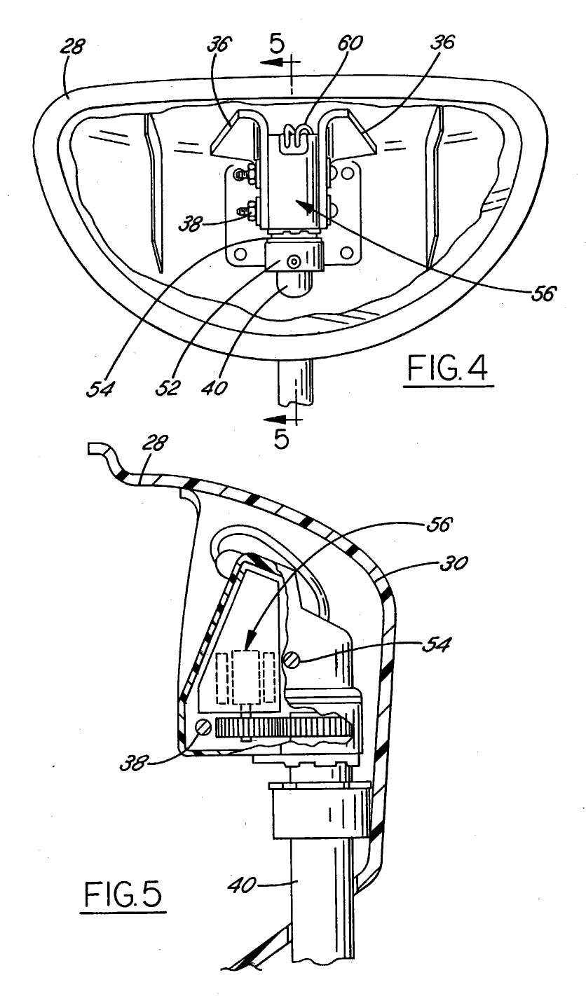

As best seen in FIGS. 4 and 5, the mounting support 18 extends within a tubular portion 40 of the curved back plate 30 and is secured to a mounting clamp 52 via a bolt 54 or some other suitable fixation device. The mounting clamp 52 is preferably a plastic material such as nylon and has a base portion 54 that seats an electronic actuator 56.

An electronic actuator 56 is seated on top of the tubular portion 40. Brackets 36 are affixed to the curved back plate 30 and extend outwardly in generally parallel relationship where they receive a bolt 38 that couples the brackets 36 to the electronic actuator 56.

The electronic actuator 56 is coupled to an electronic controller (shown as 58 in FIGS. 2 and 158 in FIG. 6) contained within the cab area 17 of the vehicle 10 via electric leads 60. The leads 60 are preferably extended through the hollow mounting support 20 and within the hood 12 of the vehicle 10 to the cab area 17. The electronic controller 58 is contained within the dashboard region of the cab area 17 and within easy access of the driver of the vehicle 10.

Each mirror assembly 22, 24 is mounted to the respective fender 14, 16 so that the reflective surface 46 has a fixed up and down visual orientation (along the y-axis or vertical adjustment). However, through use of the coupled electronic controller 58 and electronic actuator 56, complete electronic adjustment of the mirror assembly 22 rightward or leftward (corresponding to a counterclockwise or clockwise adjustment, (i.e., horizontal adjustment) of the mirror assembly 22) is obtained by the operator within the cab area 17 without the need for external assistance. This allows complete field of vision to the area in front and to the side of the bus 10 for any vehicle operator.

To accomplish this counterclockwise or clockwise adjustment about a horizontal plane, the electronic controller 58 is used by the operator in the cab area 17 to control the electronic actuator 56 that adjusts the mirror assembly 22, 24 in a rightward and leftward direction.

As best shown in FIG. 3, the electronic actuator 56 pivots, or swivels, clockwise or counterclockwise about a horizontal plane in response to an electronic signal sent from the electronic controller 58 via electric leads 60. The actuator 56 pivots about a center point 80 defined by the length of the tubular portion 40 and mounting support 20, which remain stationary. The pivoting of the electronic actuator 56 in turn causes the coupled arcuate mirror 26 and curved back plate 30 to pivot in response. The amount of pivoting of the mirror assembly 22 about the center point 80 is restricted in an about horizontal plane direction internally within the actuator 56 to an amount corresponding to a predetermined angle α. The angle α is a comparison of the relative orientation of the mirror assembly along a vertical plane 70 in a first position, corresponding to a centered position, and a second position, corresponding to a counterclockwise most pivoted position defining a vertical plane 70A or clockwise most pivoted position defining a vertical plane 70B.

The vertical plane 70, 70A, 70B, as shown in FIG. 3, is defined as by a vertical plane extending from the corners 77, or outermost edges, of the curved back plate 30 through the center point 80. Preferably, the complete range of angle α is limited to about 45 degrees when comparing the mirror assembly 22 in the centered position with either the counterclockwise most or clockwise most position.

The electronic actuator 56 describes any type of remotely controllable electronic motor that can swivel, or otherwise rotate, clockwise or counterclockwise about a horizontal plane about a fixed vertical center point 60 as will be understood by one of skill in the art. One preferred electronic actuator 56 (shown in FIGS. 4 and 5) and electronic controller 58 (shown in FIG. 2) combination that meets these requirements is a servomotor 56 electronically coupled to a toggle switch type controller 58. In this embodiment, the depressing of the toggle switch 92 by the operator in a leftward or rightward direction within the cab area 17 induces an electronic signal to be sent to the servomotor. The servomotor 56 interprets the electronic signal and generates a direct current within its coupled magnetic coils (not shown) in response to the electronic signal. The direct current creates a magnetic field that induces a shaft portion (not shown) of the servomotor 56 to rotate clockwise or counterclockwise in response to the magnetic field. The arcuate mirror 26 and mirror assembly 22 are then adjusted rightward or leftward in response to the this rotation to improve the field of vision in front of and to the side of the vehicle 10.

The movement clockwise or counterclockwise is limited in two distinct ways. First, the operator may simply return the toggle switch 92 to its normal position if the mirror adjustment is satisfactory. Second, the servomotor 56 itself may have a limiter to restrict the clockwise or counterclockwise rotation of the mirror assembly 22 as described above corresponding to angle α.

Another preferred electronic actuator 56 that may be used is a stepper motor electronically coupled to an appropriate controller (shown as 158 in FIG. 6). Most steppers, as they are also known, can be stepped at audio frequencies, allowing them to spin quite quickly. With an appropriate controller, preferably a dial controller 158, they may be started and stopped “on a dime” at controlled orientations. Thus, in this preferred embodiment, the operator turns the dial 160 of dial controller 158 clockwise or counterclockwise to a desired position. An audio signal is sent to the stepper motor as a function of the dialed position. The stepper motor receives the audio signal and rotates clockwise or counterclockwise to a precise location in response to the audio signal. As one of ordinary skill appreciates, the controller 158 itself has a built in rotation-limiting feature that is dependent upon the number of allowable dial positions. Of course, while the preferred embodiments as described above in FIGS. 4 and 6 represent two preferred actuators and controllers for controlling the movement of the mirror 26, any number of other types of actuator devices may be utilized.

The present invention addresses problems with typical crossview mirrors found in the prior art by allowing the arcuate mirror 26 to be adjusted rightward or leftward as seen by the operator of the vehicle 10 to ensure the minimization of blind spots in front of and along the side of the vehicle 10. This adjustment takes place within the cab area 17 of the vehicle 10. Thus, additional personnel are not required in aiding to adjust the mirrors. Properly adjusted mirrors will add greater safety to the children who ride the bus every day.

While the invention has been described in terms of preferred embodiments, it will be understood, of course, that the invention is not limited thereto since modifications may be made by those skilled in the art, particularly in light of the foregoing teachings.

1. A crossview mirror assembly for mounting on an exterior front surface of a vehicle, the vehicle having a cab region, the crossview mirror assembly comprising:
an arcuate mirror having a reflective surface;
a frame coupled to said arcuate mirror, said frame having a tubular region, said tubular region defining a center point;
a mirror mounting support coupled within said tubular region and to the exterior front surface of the vehicle;
an electronic actuator coupled to said arcuate mirror, said electronic actuator being actuated to swivel said arcuate mirror along an x-axis and about said center point; and
an electronic controller electrically coupled to said electronic actuator and contained within the cab region, said electronic controller controlling the actuation of said electronic actuator to move said arcuate mirror clockwise or counterclockwise along a horizontal plane about said center point.

2. The mirror assembly of claim 1, wherein said electronic actuator comprises a servomotor.

3. The mirror assembly of claim 2, wherein said electronic controller comprises a toggle switch type controller.

4. The mirror assembly of claim 1, wherein said electronic actuator comprises a stepper motor.

5. The mirror assembly of claim 4, wherein said controller is a dial controller.

6. The mirror assembly of claim 1, wherein said arcuate mirror is limited in rotation about said center point to a predetermined angle relative to a centered position, wherein said predetermined angle is a defined as a comparison of a relative orientation of said arcuate mirror at a first position as compared with said centered position, said first position corresponding to a clockwise-most allowable position or to a counterclockwise-most allowable position of said arcuate mirror, said centered position located midway between said clockwise-most allowable position and said counterclockwise-most allowable position along a horizontal plane.

7. The mirror assembly of claim 1, wherein said predetermined angle is not greater than approximately 45 degrees counterclockwise or clockwise from said centered position.

8. A method for improving the field of vision of a crossview mirror assembly in front of and to the side of a vehicle, the crossview mirror assembly having an arcuate mirror and being mounted to the front fender of the vehicle using a mounting support, the mounting support also being coupled within a tubular region of the crossview mirror assembly, the tubular region defining a center point, the method comprising:
coupling an electronic actuator within the crossview mirror assembly to the arcuate mirror;
coupling an electronic controller within a cab area of the vehicle;
electronically coupling said electronic actuator to said electronic controller; and
activating said electronic controller to send an electrical signal to said electronic actuator, said electronic actuator interpreting said electronic signal and rotating in a first direction about the center point about a horizontal plane in response to said interpreted electronic signal, thereby rotating said coupled arcuate mirror in said first direction about said horizontal plane about the center point, said first direction selected from the group consisting of a clockwise direction and a counterclockwise direction.

9. The method of claim 8, wherein the rotation of said actuator is limited to a predetermined angle about said center point relative to a centered position, wherein said predetermined angle is a defined as a comparison of a relative orientation of said arcuate mirror at a first position as compared with said centered position, said first position corresponding a counterclockwise-most allowable position or to a clockwise-most allowable position of said arcuate mirror and said centered position located midway between said counterclockwise-most allowable position and said clockwise-most allowable position.

10. The method of claim 9, wherein said predetermined angle is between approximately 0 and 45 degrees clockwise or counterclockwise about said horizontal plane from said centered position.

11. The method of claim 9, wherein coupling an electronic actuator and coupling an electronic controller comprises:
coupling a servomotor within the crossview mirror assembly to the arcuate mirror; and
coupling a toggle switch type controller within a cab area of the vehicle.

12. The method of claim 11, wherein activating said electronic controller comprises:
depressing a toggle switch of said toggle switch type controller in a first direction, wherein said depression sends an electrical signal to said electronic actuator, said electronic actuator interpreting said electronic signal to rotate about the center position along a horizontal plane as a function of said interpreted electrical signal, thereby rotating said coupled arcuate mirror in said first direction about the center point, said first direction selected from the group consisting of a clockwise direction and a counterclockwise direction.

13. The method of claim 9, wherein coupling an electronic actuator and coupling an electronic controller comprises:
coupling a stepper motor within the crossview mirror assembly to the arcuate mirror; and
coupling a dial controller within a cab area of the vehicle, said dial controller having a dial rotatable between.

14. The method of claim 13, wherein activating said electronic controller comprises:
dialing said dial from a first position to a second position, thereby generating an audio signal;
sending said audio signal from said dial controller to said stepper motor, wherein said stepper motor rotates in a first direction from a first position to a second position about a center point along a horizontal plane in response to said audio signal.

15. The method of claim 14, wherein said first direction is a counterclockwise direction.

16. The method of claim 14, wherein said first direction is a clockwise direction.
